(19) United States
(12) Patent Application Publication
(10) Pub. No.: US 2015/0018056 A1
(43) Pub. Date: Jan. 15, 2015

(54) APPARATUS AND/OR KIT RELATED TO SMARTPHONE CASES

(71) Applicant: Tanuki Entertainment, Inc., Lake Stevens, WA (US)

(72) Inventor: Matthew Archer Gillikin, Lake Stevens, WA (US)

(21) Appl. No.: 13/938,998

(22) Filed: Jul. 10, 2013

(51) Int. Cl. H04M 1/04

(52) U.S. Cl. CPC H04M 1/04
USPC 455/575.8

(57) ABSTRACT

Devices, features, and aspects are drawn to using and repurposing smartphone cases. A holder insert having a frame is dimensioned to be received in a cavity of a smartphone case in place of a smartphone to repurpose the smartphone case. Once the holder insert is received in the cavity, the smartphone case in conjunction with the received holder insert functions as a holder for holding various items (e.g., photographs, identification such as driver licenses, financial media such as credit, debit, gift or prepaid cards, currency, coins, tokens, chips, cosmetics, hygiene products).

### BACKGROUND

1. Technical Field

This description generally relates to smartphones, and in particular decorative and/or protective cases for smartphones, often referred to as smartphone cases.

2. Description of the Related Art

While not usually required, smartphone cases have become increasingly popular as a means of physically protecting and/or decoratively personalizing smartphones. In some instances, users may employ a smartphone case to improve signal reception or to serve as an extra power source for the smartphone.

Smartphone cases are typically generally rectangular in shape, and have an opening or cavity sized and dimensioned to closely removably receive the generally rectangular shape of smartphones. The smartphone may be retained in the cavity via at least a friction fit, or even via an interference fit. Often smartphone cases are at least partially open on a front thereof, providing direct physical tactile access to a touchscreen of the smartphone. Other smartphone cases have a transparent front, providing visual and indirect physical tactile access to the touchscreen.

As smartphone cases have become increasingly prevalent, smartphone case designs have proliferated, as have the number of manufacturers or distributors of smartphone cases. Many smartphone case manufacturers or distributors are after-market entities with no formal ties to smartphone manufacturers. Due in part to the competitive nature of the after-market accessory business, these after-market entities often manufacture and distribute large volumes of smartphone cases before, or simultaneously with, the release of new models of smartphones. Typically, these after-market entities do not have formal or official access to the dimensions of the smartphone before the actual release of the smartphone. Thus, the after-market entities rely on information from informal sources, for example employees of the companies that manufacture or assemble the smartphones who are not authorized to release such information. This information is often inaccurate, leading to improper fit between the smartphone case and the intended smartphone. This may result in a large number of unusable or surplus smartphone cases. Given the increasing number of smartphone manufacturers and models, as well as the increasing frequency of releases of updated smartphones, the number of surplus smartphone cases is greatly increasing.

In other instances, the after-market entity or other smartphone case manufacturer may release correctly dimensioned smartphone cases, yet may still overestimate the demand for such smartphone cases. This becomes more problematic as the number of designs (e.g., ornamental) for a smartphone case for a specific smartphone make and model increase. For instance, a smartphone case manufacturer or distributor may produce smartphone cases for a given smartphone make or model in a dozen different colors or patterns (e.g., zebra stripe, team logos). Again, given the increasing number of smartphone manufacturers and models, as well as the increasing frequency of releases of updated smartphones, the number of surplus smartphone cases is greatly increasing.

In yet other instances, a smartphone owner or end user may purchase multiple smartphone cases for a given instance of a smartphone. For example, as the smartphone owner or end user's aesthetic tastes evolve, or as smartphone cases with new ornamental designs are released. Such may leave the smartphone owner or end user with surplus smartphone cases.

### BRIEF SUMMARY

It is desirable to eliminate the waste of surplus smartphone cases. For example, it may be advantageous to allow smartphone cases, whether surplus or not, to be repurposed, for instance as holders for various types of objects (e.g., photographs or pictures, coins or currency, cosmetics, identification such as drivers licenses, financial media such as credit, debit and/or gift or prepaid cards, cigarettes, hygiene products, and the like). For instance, a holder insert may allow repurposing of a smartphone case as a folio or album, a wallet, or a cosmetic compact, to name a few examples.

A conversion kit may be summarized as including a smartphone case, the smartphone case having a cavity with at least one inner sidewall, the cavity having a length and a width, the length and the width sized to securingly removably receive a smartphone in the cavity of the smartphone case; and a holder insert, the holder insert having a frame, the frame having a length and a width, the length and the width sized to be securingly received by the cavity of the smartphone case via a friction fit with the at least one inner sidewall of the smartphone case. The length and the width of the cavity of the smartphone case may be sized to securingly removably receive the smartphone in the cavity of the smartphone case via a friction fit with the at least one inner sidewall of the smartphone case, and the length and the width of the frame of the holder insert may be sized to be securingly removably received by the cavity of the smartphone case via a friction fit with the at least one inner sidewall of the smartphone case. The length and the width of the cavity of the smartphone case may be sized to securingly removably receive the smartphone in the cavity of the smartphone case via a friction fit with the at least one inner sidewall of the smartphone case, and the length and the width of the frame of the holder insert may be sized to be securingly received by the cavity of the smartphone case via at least a friction fit with the at least one inner sidewall of the smartphone case. The smartphone case may have a rear wall and the holder insert may include a front member that forms at least one pocket with at least the rear wall of the smartphone case when the frame of the holder insert is securingly received in the cavity of the smartphone case. When the frame of the holder insert is securingly received in the cavity of the smartphone case, the front member of the holder insert may be physically coupled for pivotal movement with respect to the rear wall of the smartphone case. The holder insert may have a pair of accordion sidewalls, and may form at least one expandable pocket with at least one inner wall of the smartphone case. The front member of the holder insert may be translucent. The front member of the holder insert may be a mesh material. The holder insert may form a single pocket.

The holder insert may further include at least one fastener selectively operable to secure an opening in the single pocket in a closed configuration. The holder insert may include a front member and a number of intermediate members, and pairs of adjacent ones of the front and the intermediate members may form a plurality of pockets. The smartphone case may have a rear wall and, when the frame of the holder insert is securingly received in the cavity of the smartphone case, the front and intermediate members of the holder insert may be physically coupled for pivotal movement with respect to the rear wall of the smartphone case. The holder insert may have at least one pair of accordion sidewalls, and the plurality of pockets may be expandable. The front and the intermediate members may be transparent and may form a folio.

The holder insert may further include a number of fasteners selectively operable to secure a respective opening in a least one of the pockets in a closed configuration.

The holder insert may further include at least one protrusion positioned, sized and dimensioned to be closely received by an aperture in the smartphone case as the smartphone case was manufactured.

A holder may be summarized as including a smartphone case, the smartphone case having a cavity with at least one inner sidewall, the cavity having a length and a width, the length and the width sized to securingly removably receive a smartphone in the cavity of the smartphone case; and a holder insert securingly received by the cavity of the smartphone case via at least a friction fit with the at least one inner sidewall of the smartphone case. The smartphone case may have a rear wall and the holder insert may include a front member that forms at least one pocket with at least the rear wall of the smartphone case when the frame of the holder insert is securingly received in the cavity of the smartphone case, and the front member of the holder insert may be physically coupled for pivotal movement with respect to the rear wall of the smartphone case. The holder insert may have a pair of accordion sidewalls, and may form at least one expandable pocket with at least one inner wall of the smartphone case. The smartphone case may have a rear wall, and the holder insert may include a front member and a number of intermediate members, and pairs of adjacent ones of the front and the intermediate members may form a plurality of pockets, and, when the frame of the holder insert is securingly received in the cavity of the smartphone case, the front and the intermediate members of the holder insert may be physically coupled for pivotal movement with respect to the rear wall of the smartphone case. The holder insert may have at least one pair of accordion sidewalls, and the plurality of pockets may be expandable.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements and angles are arbitrarily enlarged and positioned to improve drawing legibility. Further, the particular shapes of the elements as drawn are not intended to convey any information regarding the actual shape of the particular elements, and have been solely selected for ease of recognition in the drawings.

FIG. 1 shows a smartphone and a conversion kit including a smartphone case and a holder insert for repurposing the smartphone case, according to one illustrated embodiment.

FIG. 2A shows the holder insert of FIG. 1 forming a wallet, according to one illustrated embodiment.

FIG. 2B shows the holder insert of FIG. 1 forming a cosmetics compact, according to one illustrated embodiment.

FIG. 2C shows the holder insert of FIG. 1 forming a folio or album for holding pictures or photographs, according to one illustrated embodiment.

FIG. 2D shows the holder insert of FIG. 1 forming an absorbent product holder, according to one illustrated embodiment.

FIG. 2E shows the holder insert of FIG. 1 forming a cigarette case, according to one illustrated embodiment.

FIG. 2F shows the holder insert of FIG. 1 forming a coin or token case, according to one illustrated embodiment.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with mobile devices have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

Reference throughout this specification to “one embodiment” or “an embodiment” means that a particular feature, structure or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The headings provided herein are for convenience only and do not interpret the scope or meaning of the claimed invention.

Proliferation of the smartphone is a modern phenomenon. Due to their enhanced functionality, and relative ease of use, smartphones are increasingly common. Cases can be acquired which hold smartphones, for example, through friction fitting the smartphone into a correspondingly sized cavity in the corresponding smartphone case. As smartphones have proliferated, so too have smartphone cases.

Over time, smartphones change in shape, due, for example, to the introduction of more advanced and differently shaped models. Thus, the retirement of smartphone models can render associated smartphone cases obsolete. As previously noted, smartphone case manufacturers or distributors often manufacturer and distribute smartphone cases based on unofficial information or even guesses about the specific dimensions of a yet-to-be-released smartphone. Furthermore, users may acquire new cases over time. Thus, there is an increasing set of smartphone cases that are disused, either because a user no longer finds them stylish, or because the case no longer fits a commonly available smartphone.

Touchscreen smartphones are a common type of smartphone that have seen great proliferation. Many smartphone cases are designed to accommodate touchscreen smartphones. As discussed above, smartphone cases may be or become disused. It is desirable to promote the use of these disused smartphone cases. Aspects of this disclosure are drawn to using disused smartphone cases. For example, it may be possible to repurpose a disused smartphone case as a holder for certain items. This may be accomplished by a holder insert which is inserted into a smartphone case to enable the smartphone case to be used as a holder for items, for example, a wallet, a makeup case, a photo holder, sanitary storage, or a cigarette or coin holder. In some instances, the smartphone case may never have been used. For example, the smartphone case may be dimensioned incorrectly, and not actually fit a given, or even any, smartphone. Also, for example, the smartphone case may simply be the result of overproduction. As an even further example, the smartphone case may have been manufactured and/or distributed with the express purpose or intent to be used as a holder for objects other than smartphones, for example distributed as part of a kit which includes a holder insert.

A common layout of smartphones includes a body with a front facing touchscreen as both a user input and user output (user I/O) mechanism. Smartphone cases typically have internal cavities with inner or internal dimensions that are shaped, dimensioned or sized to closely receive exterior or external dimensions of the smartphone at least partially therein. A smartphone case may have an inner sidewall at least partially defining at least a partial cavity having a length and width allowing the smartphone case to releasably hold or retain a corresponding smartphone make and model therein. Because smartphones often have a touchscreen on a front or face thereof, a smartphone case may be open on at least a portion of a front thereof to expose the touchscreen for use by a user without having to remove the smartphone from the smartphone case.

The holder insert comprises a frame with an exterior shape, dimensions or size (e.g., length and width) substantially corresponding to the external or exterior shape, dimensions or size (e.g., length and width) of at least a perimeter or a corresponding smartphone make and model. This allows substitution of the holder insert for a smartphone in the cavity of the smartphone case. The holder insert may be kept coupled in the receiving cavity of the smartphone case by at least a friction fit between one or more frame members making up the frame and one or more inner walls of the smartphone case such as a sidewall. For example, one or more inner sidewalls of the smartphone case may be friction fitted with one or more elements or portions of the frame, thereby securingly holding the holder insert in the receiving cavity of the case. The holder insert may, optionally, be releasably held or removable from the smartphone case, permitting reuse of either the holder insert, the smartphone case, or both.

Discussing embodiments and aspects of the frame in more detail, the frame comprises one or more frame members. The dimensions of the frame members define the dimensions of the frame and, thus, the dimensions of the holder insert. Frame members may include side members, which may define a length of the frame and, thus, the length of the holder insert. Top or bottom members may define a width of the frame and, thus, the width of the holder insert. The holder insert may comprise one or more panels, such as a front panel, a back panel, and/or both a front and a back panel. The holder insert may include one or more intermediate panels, which are intermediate with respect to the front panel and a back panel of either and/or both of the holder insert and the smartphone case. The panels may in themselves constitute frame members, physically coupling with or to one or more other frame members. Frame members may couple to frame members to form the frame of the holder insert. For example, a front panel could couple with side members to form the frame of the holder insert. One or more frame members can be pivotably coupled, for example, by a hinge which may be a component of the holder insert.

The cavity of the smartphone case is defined by one or more sidewalls of the case. The frame of the holder insert may fit against one or more sidewalls of the smartphone case, securing the holder insert in the cavity of the smartphone case. For example, a frame member such as a side member may friction fit or interference fit against a sidewall of the cavity, removably or releasably securing the holder insert in the smartphone case. Of course more than one frame member may fit one or more portions of the cavity of the smartphone case to secure the holder insert in the smartphone case.

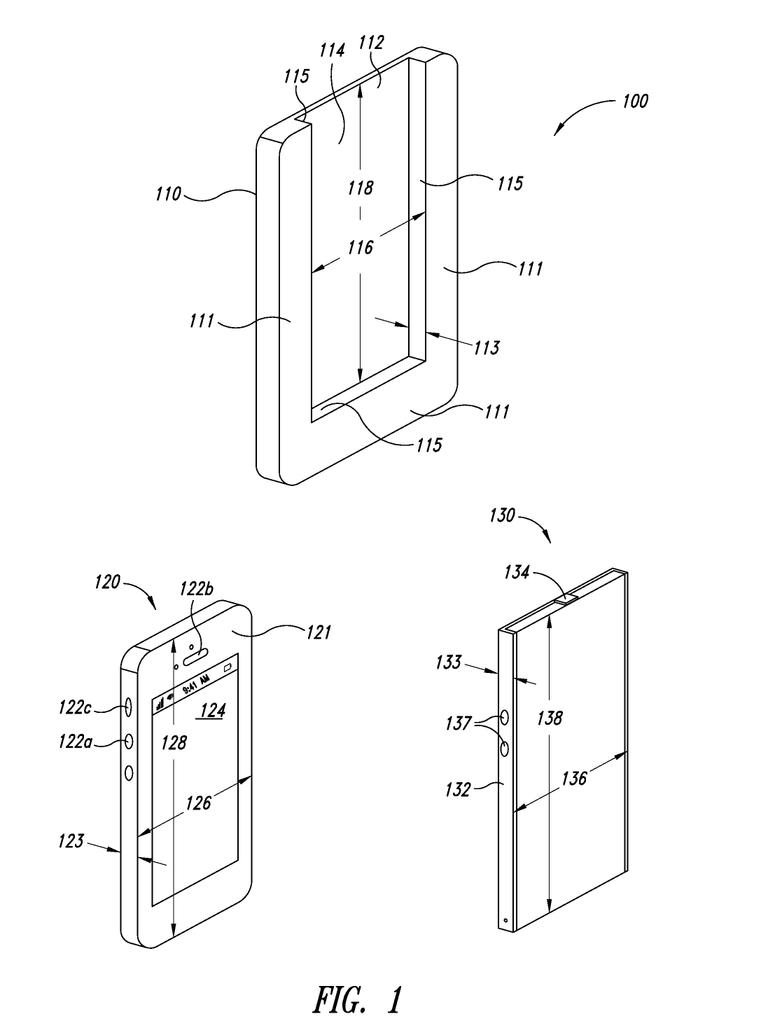

FIG. 1 shows a smartphone 120 and a conversion kit 100 comprising a smartphone case 110 designed to removably, releasably hold the smartphone 120, and a holder insert 130 receivable by the smartphone case 110 to repurpose the smartphone case 110 as a holder.

The smartphone 120 typically has a rectangular profile defined by two pairs of opposed edges, namely a pair of opposed side edges, and a pair of opposed top and bottom edges. The smartphone 120 has a face 121 and a back (not shown). The smartphone has a width 126 defined as a distance between the opposed side edges and a length 128 defined as a distance between the opposed top and bottom edges. The width 126 and the length 128 correspond to the outer, external or exterior dimensions of the smartphone 120. The smartphone 120 may also have a thickness 123, defined as a dimension between the face 121 and the back of the smartphone.

The smartphone 120 typically has a touchscreen 124 for receiving user input and providing user output. The smartphone 120 may optionally have one or more actuatable controls 122a (e.g., buttons, switches, keys) and/or transducers 122b (e.g., speakers, microphones, cameras or lenses) and/or wired communications ports 122c (e.g., USB female port, Apple® 30 Pin female port, Apple® Lightning® connector female port). A layout (e.g., position, orientation) of the actuatable controls 122a, transducers 122b, and/or wired communications ports 122c may be unique to the particular make and model of the smartphone 120.

Smartphone case 110 includes one or more walls 111 that define a cavity 112 having an interior or internal shape, and dimensions or size to securingly and removably or releasably receive smartphone 120. The cavity 112 is defined by at least one inner sidewall 115, and optionally by a rear wall 114 of the smartphone case 110 if present. The cavity 112 and the interior or internal dimensions thereof, including relative depth, are further defined by the shape, dimensions or size of the inner sidewall 115. The inner sidewall 115 is illustrated in FIG. 1 as continuous, extending over substantially three sides. Notably, as illustrated in FIG. 1, the inner sidewall 115 includes a single pair of opposing sides (e.g., left:right) and one additional side (e.g., a top or bottom). Notably, in some implementations the inner sidewall 115 may include two pairs of opposing sides (e.g., top:bottom, left:right). In yet other implementations, the inner sidewall 115 may include only a single pair of opposing sides, with no additional sides (e.g., no top and no bottom).

The cavity 112 has internal dimensions (e.g., a width 116 a length 118, and optionally a depth 113) sized to closely receive the exterior or external dimensions (e.g., width 126 and length 128) of the smartphone 120 therein. As is clear upon review of FIG. 1, the cavity 112 receives the smartphone 120 with the touchscreen 124 of the smartphone 120 exposed for use. Where the smartphone case 110 has a rear wall (not shown), which is optional, the back (not shown) of the smartphone 120 may be adjacent and/or at least partially covered by the rear wall (not shown) of the smartphone case 110. The inner sidewall 115 has an interior shape, dimension or size to at least frictionally engage the exterior or outer portion edges or periphery of the smartphone 120. Such inner portions of the inner sidewall 115 preferably provide for a removable or releasable fit with smartphone bodies.

The smartphone case 110 may have one or more holes, openings, ports or apertures sized and positioned to accommodate respective ones of the actuatable controls 122a, transducers 122b, and/or wired communications ports 122c of the smartphone 120.

Typically, the width 116 and length 118 of the cavity 112 of the smartphone case 110 at least approximately respectively match the width 126 and length 128 of a corresponding smartphone 120 because the smartphone case 110 is designed with the intent to hold the smartphone 120. As used herein and in the claims, the term approximately means sufficient close to achieve a desired fit, for example a friction fit or an interference fit. Typically to achieve such a fit, the frame will have outer dimensions slightly larger than the interior dimensions of the cavity 112. As previously explained, in some instances the dimensions may not match, for example due to reliance on inaccurate pre-release information regarding the dimensions of a smartphone scheduled or expected to be released at some time after the smartphone case 110 is designed and/or manufactured.

The holder insert 130 is shaped, sized and/or dimensioned to be received and held in the cavity 112 of the smartphone case 110 instead of, or in place of, the smartphone 120, to repurpose the smartphone case 110 as a holder.

The holder insert 130 has a frame 132 comprising one or more frame members. The frame 132 has an exterior or external shape, dimension or size that at least approximately matches the interior or internal shape, dimensions or size (e.g., width 116 and a length 118) of the cavity 112 of the smartphone case 110. For example, the frame 132 has an exterior or external width 136 and length 138, which may be sized to achieve a friction fit or even a low interference or interference fit with the inner sidewall 115 of the smartphone case 110.

In some instances, the width 136 of the holder insert 130 at least approximately matches a width 126 of the smartphone 120, and the length 138 of the holder insert 130 at least approximately matches the length 128 of the smartphone 120. This means that in situations where the smartphone case 110 correctly fits the smartphone 120, both the width 136 and the length 138 of the holder insert 130 will at least approximately match the width 116 and the length 118 of the cavity 112 of the smartphone case 110. However, as previously noted the smartphone cases 110 are not always correctly dimensioned for the dimensions of the smartphone 120 that actually is released. Thus, it is typically preferable to match the external or exterior dimensions of the holder insert 130 directly to the internal or interior dimensions of the cavity 112 of the smartphone case 110.

The frame 132 has at least two opposed sides, portions, elements or members, which are spaced apart to securingly engage respective portions of the inner sidewall 115 of the cavity 112 of the smartphone case 110. The frame may include one or more additional sides, portions, elements or members (i.e., joining member) which physically couple the at least two opposed sides, portions, elements or members. For example, a panel such as a front or back panel may join the at least two opposed sides, portions, elements or members. Additionally or alternatively, one or more top or bottom portions, elements or members may join the at least two opposed sides, portions, elements or members. Additionally or alternatively, one or more cross or diagonal portions, elements or members may join the at least two opposed sides, portions, elements or members.

The frame 132 defines the external or exterior dimensions of the holder insert 130. In particular, the frame 132 defines the width 136 and length 138 of holder insert 130. The frame 132 also defines a thickness 133 of the holder insert 130. The thickness 133 of the holder insert 130 may at least approximately match a depth 113 of the cavity 112 as determined by the inner sidewall 115 of the smartphone case 110. Because the thickness 133 and other external or exterior dimensions 136, 138 of the frame 132 at least approximately match the respective depth 113 and other internal or interior dimensions 116, 118 of cavity 112, the holder insert 130 is, for example, substitutable for the smartphone 120 in smartphone case 110 to repurpose the smartphone case 120 as a holder. As previously noted, the holder insert 130 may be removably, releasably secured in the cavity 112, for instance via a friction fit, low interference fit or interference fit between the inner sidewall 115 and the one or more frame sides, portions, elements or members of the frame 132.

While in the embodiment shown in FIG. 1, the inner sidewall 115 is a discontinuous sidewall bounding an area substantially on three sides, this is by way of explanation, not limitation. A smartphone case 110 may have numerous configurations of sidewall(s). For example, a smartphone case 110 may have two opposing sidewalls, such as right and left sidewalls, or top and bottom sidewalls. Alternatively or additionally, a smartphone case may have a continuous sidewall that completely encircles or encompasses an area. Sidewalls may be continuous or discontinuous, and may be rectangular or other shapes. An inner sidewall will have an inner surface which may physically couple to, or physically engage in some fashion (e.g., friction fit, interference fit) the frame, a portion of the frame, or a frame member of the holder insert.

Holder insert 130 may optionally have a discrete fastener 134 to fasten the holder insert 130 to smartphone case 110 when holder insert 130 is inserted into smartphone case 110. The discrete fastener 134 may take a variety of forms, for example including one or more magnets, snap fasteners, hook and loop fasteners, or detents.

The holder insert 130 optionally includes a number of projections or elements 137 that extend from a surface thereof, positioned, spaced and/or aligned to be received at least partially by respective holes, openings, ports or apertures 122 in the smartphone case 110. The projections or elements 137 may optional fasten or secure the holder insert 130 in the smartphone case 110.

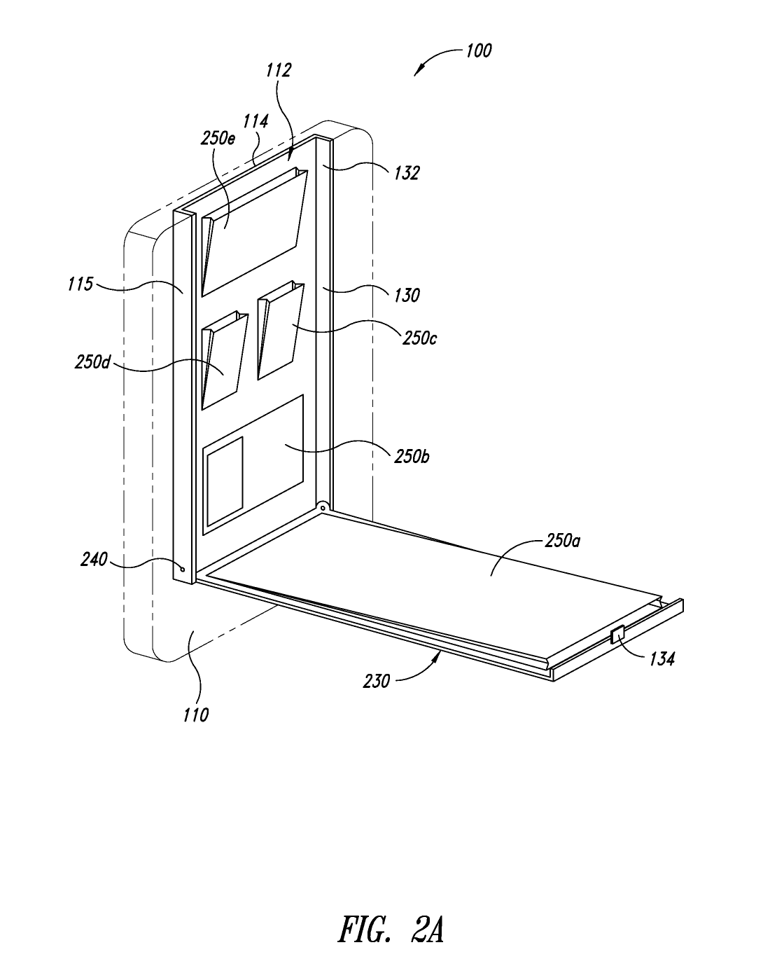

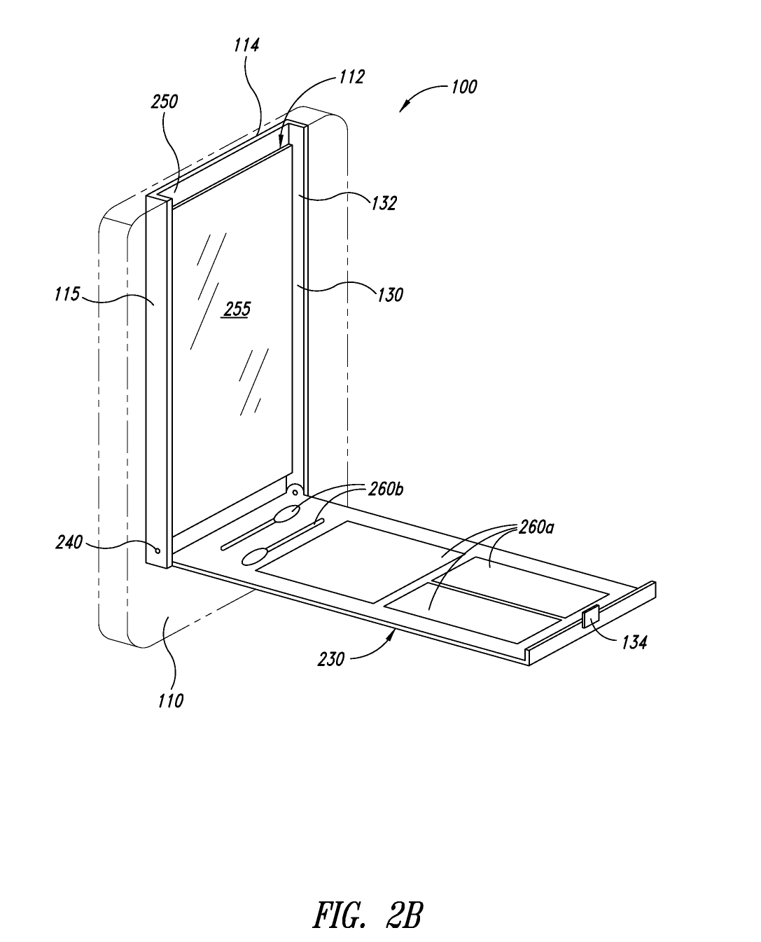

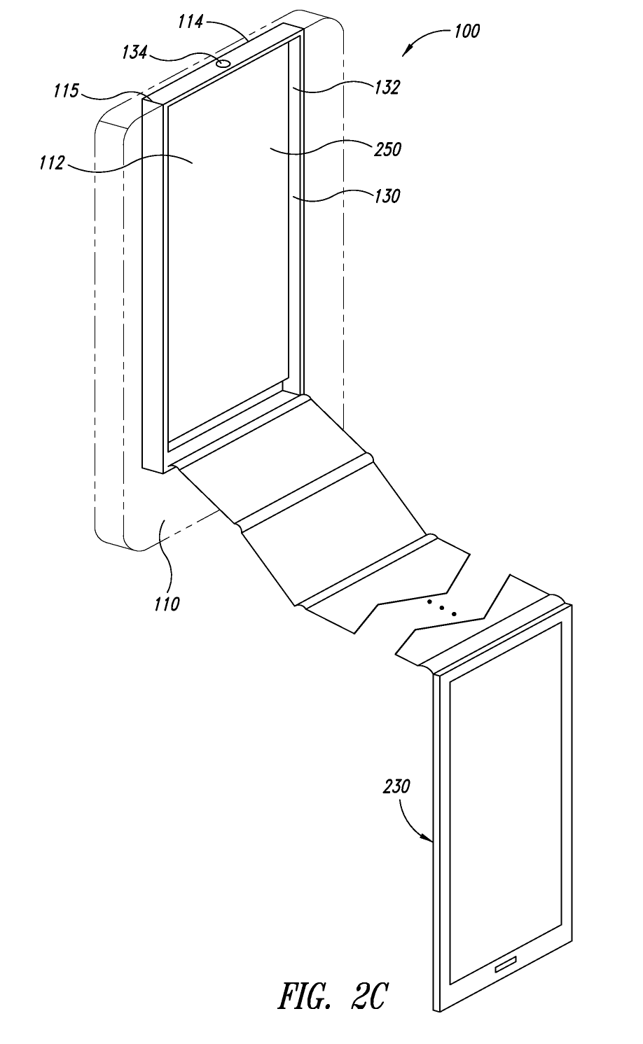

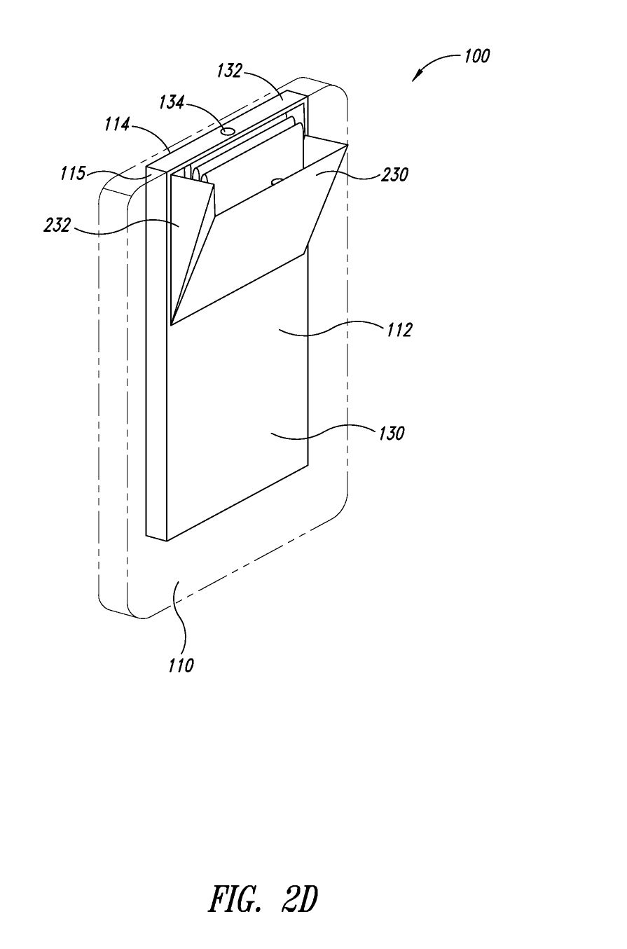

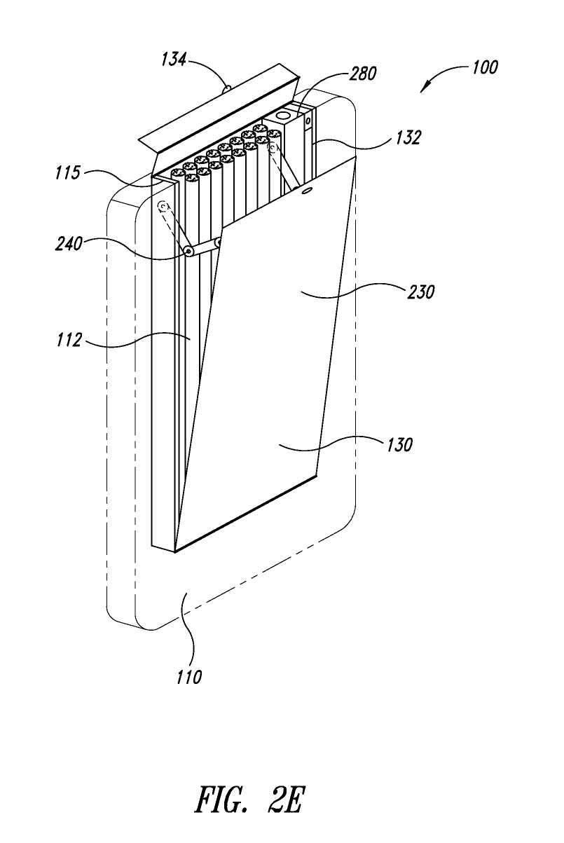

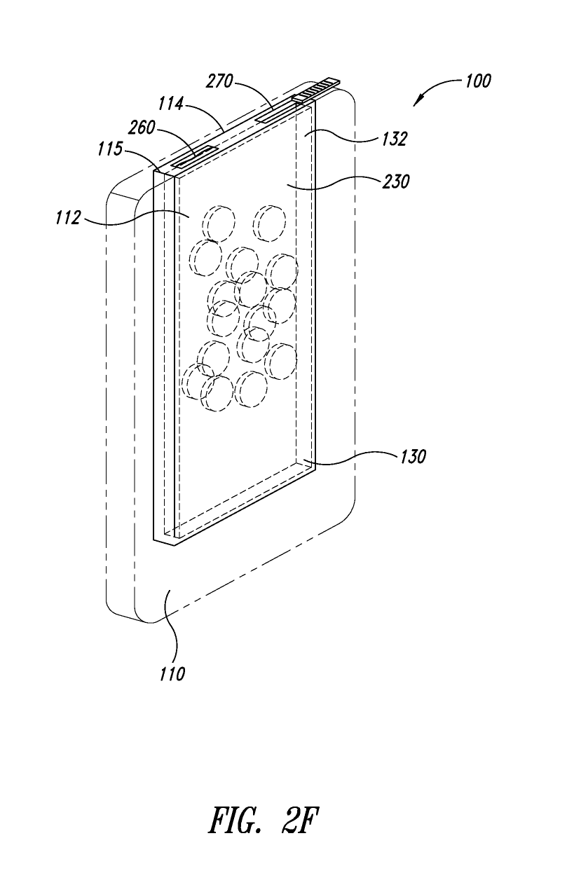

FIGS. 2A-2F show holders identical or similar to those described with reference to FIG. 1. Similar or identical structures are identified using the same reference symbols as employed in FIG. 1.

FIG. 2A shows a holder insert 130 secured in a smartphone case 110 to repurpose the smartphone case 110 as a holder in form of a wallet, according to at least one illustrated embodiment.

In the example shown in FIG. 2A, holder insert 130 provides hard shell storage inside the smartphone case 110. The rear wall 114 defines part of the cavity 112 of the smartphone case 110, into which the holder insert 130 is received and secured, for instance via a friction fit. The inner sidewall 115 further defines the dimensions of the cavity 112. The length and width of holder insert 130 at least approximately match the length and width of the cavity 112. That is, the frame 132 and the frame members of holder insert 130 are sized to removably, releasably friction fit the holder insert 130 in the cavity 112 of the smartphone case 110. Specifically, one or more inner surfaces of the sidewall 115 frictionally engage at least portions of the frame 132.

The holder insert 130 has a front panel 230 which rotates relative to the rear wall 114 via a pivot mechanism 240 when the holder insert 130 is fully inserted into the cavity 112 of case 110. In one example, the pivot mechanism 240 comprises a hinge including a hinge pin. The front panel 230 is coupled to the frame 132 via the pivot mechanism 240. The fastener(s) 134 fastens or unfastens the front panel 230 to pivot relative to the rear wall 114 via pivot mechanism 240. When the front panel 230 is pivoted open relative to the rear wall 114, storage pockets 250 are exposed for access. Storage pockets 250 may include receipt storage pocket 250a, license pocket 250b, financial media pockets 250c, 250d for credit, debit, gift, and/or prepaid cards and the like, and currency or cash pocket 250e.

FIG. 2B shows a holder insert 130 secured in the smartphone case 110 to repurpose the smartphone case 110 as a holder in the form of a makeup or cosmetics compact, according to at least one illustrated embodiment.

In the example shown in FIG. 2B, the holder insert 130 provides makeup element or cosmetic storage inside the smartphone case 110. The rear wall 114 defines part of the cavity 112 into which the holder insert 130 is secured, for example via a friction fit. The length and width of holder insert 130 at least approximately matches the length and width of the cavity 112. The holder insert 130 has a front panel 230 which pivots relative to the rear wall 114 via pivot mechanism 240 when the holder insert 130 is fully secured in the cavity 112 of the smartphone case 110. In one example, the pivot mechanism 240 comprises a hinge including a hinge pin. The fastener(s) 134 fastens or unfastens the front panel 230 to pivot relative to the rear wall 114 via the pivot mechanism 240. The fastener(s) 134 may include a button, snap, hook and loop fastener, or other type of fastener, which may be biased into a closed or locked position, for instance via a spring force.

The front panel 230 of the holder insert 130 pivots open relative to the rear wall 114 of the smartphone case 110, to expose and/or provide access to the makeup or cosmetic elements stored in the holder insert 130. As shown in FIG. 2B, the holder insert 130 optionally has a rear wall 250 which fits against the rear wall 114 of the smartphone case 110 in the cavity 112 when the holder insert 130 is securely received in the cavity 112 of the smartphone case 110. A mirror 255 is supported by the rear wall 250. Pivoting the front panel 230 of holder insert 130 open relative to rear wall 114 of smartphone case 110 exposes the mirror 255, allowing a user to view him or herself and to provide access to makeup or cosmetics application tools 260b.

FIG. 2C shows a holder insert 130 secured in a smartphone case 110 to repurpose the smartphone case 110 as a holder in the form of a photograph holder, folio or album, according to at least one illustrated embodiment.

In the example shown in FIG. 2C, the holder insert 130 provides photograph or picture storage inside the smartphone case 110. The rear wall 114 defines part of a cavity 112 into which the holder insert 130 is secured, for example via a friction fit. The length and width of holder insert 130 at least approximately matches the length and width of cavity 112. The holder insert 130 may have a hard or rigid (e.g., ABS plastic) body or shell with a back panel 250 and a front panel 230. The back panel 250 abuts the rear wall 114 in the cavity 112 of the smartphone case 110. Fastener(s) 134 fastens or unfastens the front panel 230 to move relative to back panel 250. This provides access from an exterior thereof to photographs stored therein. The fastener(s) 134 may include a button, snap, hook and loop fastener, or other type of fastener. As shown particularly in this embodiment, the front panel 230 may be coupled to the back panel 250 of the holder insert 130 by a folio or album of photograph sleeves or holders.

FIG. 2D shows a holder insert 130 secured in a smartphone case 110 to repurpose the smartphone case 110 as a holder for absorbent articles (e.g., tissue or other hygiene product).

In the example shown in FIG. 2D, the holder insert 130 provides a storage space, such as a pocket or cavity, inside the smartphone case 110. The rear wall 114 defines part of the cavity 112 into which the holder insert 130 is securely received, for example via a friction fit. The length and width of holder insert 130 correspond, allowing holder insert 130 to at least approximately match the length and width of the cavity 112. The holder insert 130 may have a hard body or shell, for instance with a front panel 230. Fastener(s) 134 fastens or unfastens front panel 230 to allow the front panel 230 to move relative to the rear wall 114 of smartphone case 110. This exposes and provides access to the storage space therein from an exterior thereto, providing access to the stored hygiene product. The fastener(s) may include a button, snap, hook and loop fastener or other type of fastener. As shown particularly in this embodiment, the front panel 230 may have a front panel pivoting portion which pivots to expose the storage space. As shown in FIG. 2D, the pivoting portion of front panel 230 is pivotably secured by flexible accordion flexures 232 on each side.

FIG. 2E shows a holder insert 130 secured in a smartphone case 110 to repurpose the smartphone case 110 as a holder in the form of a cigarette case, according to at least one illustrated embodiment.

In the example shown in FIG. 2E, the holder insert 130 provides a storage space for cigarettes inside the smartphone case 110. The holder insert 130 is securely received in the cavity 112 of smartphone case 110. The length and width of holder insert 130 at least approximately matches the length and width of cavity 112, allowing holder insert 130 to be secured in the cavity 112 via either a friction or interference fit. The holder insert 130 may have a hard or rigid body or shell with the front panel 230. Fastener(s) 134 fastens or unfastens front panel 230, allow the front panel 230 to pivot open. This exposes and provides access to the storage space therein from an exterior thereof, thereby providing access to stored cigarettes. The fastener(s) may include a buttons, snaps, hook and loop fastener, or other type of fasteners. As shown particularly in this embodiment, the front panel 230 may be pivotably hinged to allow opening and closing of the front panel 230 via hinge arms 240. As shown in FIG. 2E, the holder insert 130 may include a lighter 280, such as a butane lighter, with an actuation button.

FIG. 2F shows a holder insert 130 secured in a smartphone case 110 to repurpose the smartphone case 110 as a holder in the form of a coin holder, according to at least one illustrated embodiment.

In the example shown in FIG. 2F, the holder insert 130 provides storage for coins inside the smartphone case 110. The holder insert 130 is secured in the cavity 112 of the smartphone case 110. The length and width of holder insert 130 at least approximately matches the length and width of the cavity 112 of the smartphone case 110, allowing the holder insert 130 to be secured in the cavity 112, for example via a friction or interference fit. The holder insert 130 may have a hard or rigid body or shell with a front panel 230. As shown particularly in this embodiment, the front panel 230 is fixed and defines part of the interior of the holder insert 130, which may for example hold coins, tokens, or chips. Two apertures 260 and 270 provide access to the interior of holder insert 130 to insert or retrieve coins or tokens. A first aperture 260 takes the form of a slit for inserting coins, tokens or chips into the interior of the coin holder case. The first aperture 260 may comprise a rubber membrane with a slit aperture to receive coins, tokens or chips, and through which coins, tokens or chips pass into the interior of the coin holder case. A second aperture 270 may provide access to the interior of the holder insert 130. The second aperture may take the form of a sliding door to allow coins, tokens or chips to be poured out of the interior of the coin holder case.

A smartphone case may have one or more holes, apertures, ports or other openings to accommodate various elements or components (e.g., buttons, keys, speakers, microphone, camera, other sensors or transducers, wired communications ports) of the particular make and model of smartphone for which the smartphone case is designed or intended. The holder insert may have corresponding protrusions or other mechanisms for filling or obviating the holes, apertures, ports or other openings in the smartphone case. As an example, the holder insert may block off a hole formed in the smartphone case when the holder insert is inserted into a corresponding smartphone case or may have a protrusion to fill in a space allocated for a button in the smartphone case.

Although specific embodiments and examples are described herein for illustrative purposes, various equivalent modifications can be made without departing from the spirit and scope of the invention, as will be recognized by those skilled in the relevant art. The teachings provided herein can be applied broadly to smartphone cases. For example, the teachings can be used to repurpose smartphone cases to hold any number of items and the discussed examples of holder inserts and purposes thereof is not exhaustive. The smartphone case may any number of shapes corresponding to different smartphone shapes. The various embodiments described above can be combined to provide further embodiments. The illustrated methods can omit some acts, can add other acts, and can execute the acts in a different order than that illustrated to achieve the advantages of the invention.

These and other changes can be made to the invention in light of the above detailed description. In general, in the following claims, the terms used should not be construed to limit the invention to specific embodiments disclosed in the specification, but should be construed to include all examples in accordance with the claims. Accordingly, the invention is not limited by the disclosure, but instead its scope is to be determined entirely by the following claims.

1. A conversion kit, comprising:
a smartphone case, the smartphone case having a cavity with at least one inner sidewall, the cavity having a length and a width, the length and the width sized to securingly removably receive a smartphone in the cavity of the smartphone case; and
a holder insert, the holder insert having a frame, the frame having a length and a width, the length and the width sized to be securingly received by the cavity of the smartphone case via a friction fit with the at least one inner sidewall of the smartphone case.

2. The conversion kit of claim 1 wherein the length and the width of the cavity of the smartphone case are sized to securingly removably receive the smartphone in the cavity of the smartphone case via a friction fit with the at least one inner sidewall of the smartphone case, and the length and the width of the frame of the holder insert are sized to be securingly removably received by the cavity of the smartphone case via a friction fit with the at least one inner sidewall of the smartphone case.

3. The conversion kit of claim 1 wherein the length and the width of the cavity of the smartphone case are sized to securingly removably receive the smartphone in the cavity of the smartphone case via a friction fit with the at least one inner sidewall of the smartphone case, and the length and the width of the frame of the holder insert are sized to be securingly received by the cavity of the smartphone case via at least a friction fit with the at least one inner sidewall of the smartphone case.

4. The conversion kit of claim 3 wherein the smartphone case has a rear wall and the holder insert includes a front member that forms at least one pocket with at least the rear wall of the smartphone case when the frame of the holder insert is securingly received in the cavity of the smartphone case.

5. The conversion kit of claim 4 wherein when the frame of the holder insert is securingly received in the cavity of the smartphone case, the front member of the holder insert is physically coupled for pivotal movement with respect to the rear wall of the smartphone case.

6. The conversion kit of claim 5 wherein the holder insert has a pair of accordion sidewalls, and forms at least one expandable pocket with at least one inner wall of the smartphone case.

7. The conversion kit of claim 5 wherein the front member of the holder insert is translucent.

8. The conversion kit of claim 5 wherein the front member of the holder insert is a mesh material.

9. The conversion kit of claim 1 wherein the holder insert forms a single pocket.

10. The conversion kit of claim 9 wherein the holder insert further includes at least one fastener selectively operable to secure an opening in the single pocket in a closed configuration.

11. The conversion kit of claim 1 wherein the holder insert includes a front member and a number of intermediate members, and pairs of adjacent ones of the front and the intermediate members form a plurality of pockets.

12. The conversion kit of claim 4 wherein the smartphone case has a rear wall and, when the frame of the holder insert is securingly received in the cavity of the smartphone case, the front member of the holder insert is physically coupled for pivotal movement with respect to the rear wall of the smartphone case.

13. The conversion kit of claim 11 wherein the holder insert has at least one pair of accordion sidewalls, and the plurality of pockets are expandable.

14. The conversion kit of claim 11 wherein the front and the intermediate members are transparent and form a folio.

15. The conversion kit of claim 9 wherein the holder insert further includes a number of fasteners selectively operable to secure a respective opening in a least one of the pockets in a closed configuration.

16. The conversion kit of claim 1 wherein the holder insert further includes at least one protrusion positioned, sized and dimensioned to be closely received by an aperture in the smartphone case as the smartphone case was manufactured.

17. A holder, comprising:
a smartphone case, the smartphone case having a cavity with at least one inner sidewall, the cavity having a length and a width, the length and the width sized to securingly removably receive a smartphone in the cavity of the smartphone case; and
a holder insert securingly received by the cavity of the smartphone case via at least a friction fit with the at least one inner sidewall of the smartphone case.

18. The holder of claim 17 wherein the smartphone case has a rear wall and the holder insert includes a front member that forms at least one pocket with at least the rear wall of the smartphone case when a frame of the holder insert is securingly received in the cavity of the smartphone case, and the front member of the holder insert is physically coupled for pivotal movement with respect to the rear wall of the smartphone case.

19. The holder of claim 18 wherein the holder insert has a pair of accordion sidewalls, and forms at least one expandable pocket with at least one inner wall of the smartphone case.

20. The holder of claim 1 wherein the smartphone case has a rear wall, and the holder insert includes a front member and a number of intermediate members, and pairs of adjacent ones of the front and the intermediate members form a plurality of pockets, and, when the frame of the holder insert is securingly received in the cavity of the smartphone case, the front and the intermediate members of the holder insert are physically coupled for pivotal movement with respect to the rear wall of the smartphone case.

21. The holder of claim 20 wherein the holder insert has at least one pair of accordion sidewalls, and the plurality of pockets are expandable.
